(19) United States
(12) Patent Application Publication
(10) Pub. No.: US 2019/0273351 A1
(43) Pub. Date: Sep. 5, 2019

(54) ELECTRICAL CONNECTOR

(71) Applicant: MERSEN USA NEWBURYPORT-MA, LLC, Newburyport, MA (US)

(72) Inventors: J. Thomas ARIENO, Rochester, NY (US); Thomas A. PETOTE, Spencerport, NY (US)

(73) Assignee: MERSEN USA NEWBURYPORT-MA, LLC, Newburyport, MA (US)

(21) Appl. No.: 16/290,272

(22) Filed: Mar. 1, 2019

Related U.S. Application Data
(60) Provisional application No. 62/637,437, filed on Mar. 2, 2018.

(51) Int. Cl. H01R 39/64; H01R 4/30

(52) U.S. Cl. CPC H01R 39/64; H01R 4/308

(57) ABSTRACT

An electrical connector for establishing an electrical connection between two flatly overlapping current conducting elements,

### RELATED APPLICATIONS

This application claims the benefit of U.S. Provisional Application No. 62/637,437, filed Mar. 2, 2018, which is fully incorporated herein by reference.

### FIELD OF THE INVENTION

The present invention relates to an arrangement for forming an electrical connection between two surfaces, and more particularly, to an electrical connector for interconnecting two bus bars or the like.

### BACKGROUND OF THE INVENTION

It is known to form an electrical connection between two complimentary surfaces with a contact sheet or strip of metal formed with a plurality of parallel slits that subdivide its central region into a plurality of parallel tongues or contact lamellae extending between coplanar side portions. These tongues are twisted to lie at an angle to the plane of the side portions. Such connector is compressed between the two complimentary surfaces, resiliently deforming the lamellae so as to make very good electrical connections. (See U.S. Pat. No. 3,453,587.) Such structures find advantageous application in forming an electrical connection between two planar bus bars. In some bus bar applications, it is desirable that the bus bars rotate relative to each other or even flex slightly from a planar configuration.

The present invention provides an electrical connector for forming an electrical connection between two surfaces, wherein one surface may rotate about an axis perpendicular to the two surfaces and which may flex about said plane.

### SUMMARY OF THE INVENTION

In accordance with one aspect of the present invention, there is provided an electrical connector for establishing an electrical connection between two flatly overlapping current conducting elements, the electrical connector comprised of a plurality of spaced apart contact modules formed of louver sections held within a nonconductive frame.

In accordance with another aspect of the present invention, there is provided an electrical connector as described above, wherein the frame containing the contact module is flexible.

In accordance with another aspect of the present invention, there is provided an electrical connector as described above, wherein the frame is formed of a nonconductive polymer material.

In accordance with yet another aspect of the present invention, there is provided an electrical connector as described above, wherein each contact module is disposed within a leg section that extends outwardly from the central region of the frame.

An advantage of the present invention is an electrical connector that improves contact pressure between two flatly overlapping current conducting elements that can rotate relative to each other and that can flex relative to each other.

Another advantage of the present invention is an electrical connector as described above, wherein individual contact modules are isolated from each other in a nonconductive frame.

A still further advantage of the present invention is an electrical connector as described above, wherein each contact module can flex and be oriented in planes different from the other contact modules.

A still further advantage of the present invention is an electrical connector as described above, wherein each contact module is disposed within a leg portion that extends outwardly from a central region of the frame and each leg portion is flexible relative to the other leg portion.

These and other advantages will become apparent from the following description of a preferred embodiment of the invention, taken together with the accompanying drawings.

### BRIEF DESCRIPTION OF THE DRAWINGS

The invention may take physical form in certain parts and arrangement of parts, an embodiment of which is described in detail in the specification and illustrated in the accompanying drawings, wherein:

FIG. 1 is an exploded view of an electrical connector for forming an electrical connection between two substantially planar surfaces, illustrating one embodiment of the present invention;

FIG. 2 is an assembled view of the electrical connector shown in FIG. 1;

FIG. 3 is a partially sectioned, top plan view of the electrical connector shown in FIGS. 1 and 2;

FIG. 4 is a top plan view of an electrical connection of two conductors showing the electrical connector shown in FIGS. 1-3, disposed therebetween;

FIG. 5 is a side view of the electrical connection shown in FIG. 4;

FIG. 6 is an enlarged sectional view taken along lines 6-6 of FIG. 4 showing a contact module disposed between the two electrical conductors;

FIG. 7 is an enlarged sectional view taken along lines 7-7 of FIG. 3 showing the lamellae of a contact module within an non-conductive housing or frame;

FIG. 8 is a sectional view taken along lines 8-8 of FIG. 4 showing the contact module of FIG. 7 disposed and compressed between planar surfaces of an upper conductor and a lower conductor;

FIG. 9 is a sectional view of the lamellae of the contact module shown in FIG. 8 being compressed between the upper and lower conductors that are slightly misaligned but the lamellae still make an electrical contact therebetween;

FIG. 10 is an enlarged cross-sectional view of part of an electrical connector showing a contact module captured between two layers of a non-conductive material; and

FIG. 11 is a top plan view of an electrical connector illustrating an alternate embodiment of the present invention.

### DETAILED DESCRIPTION OF THE INVENTION

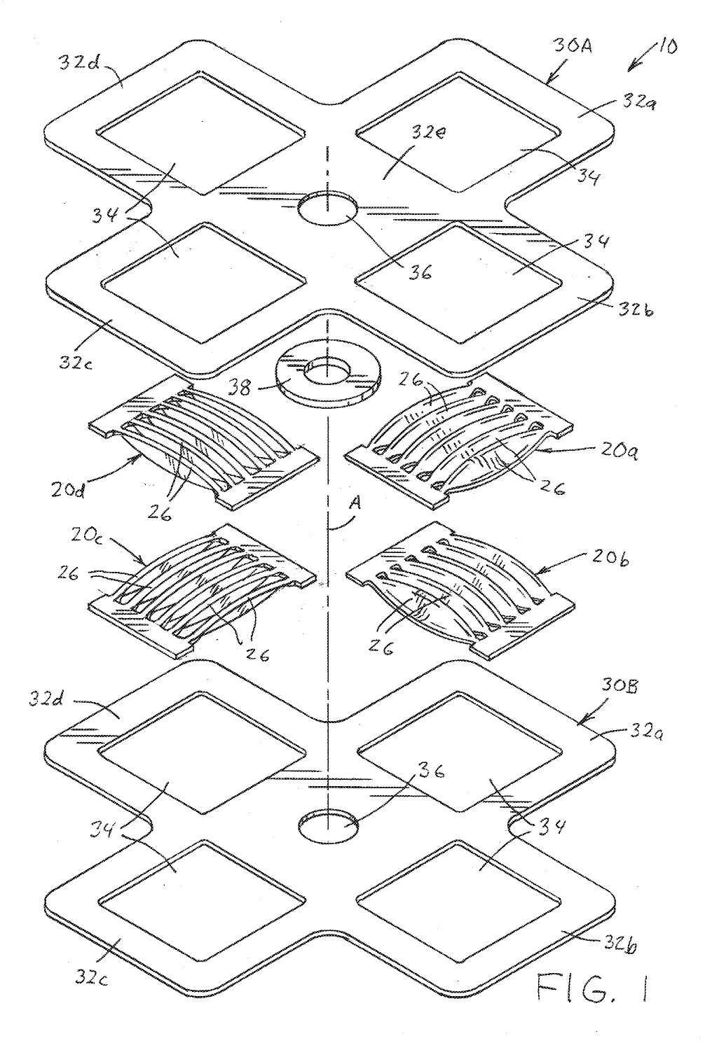

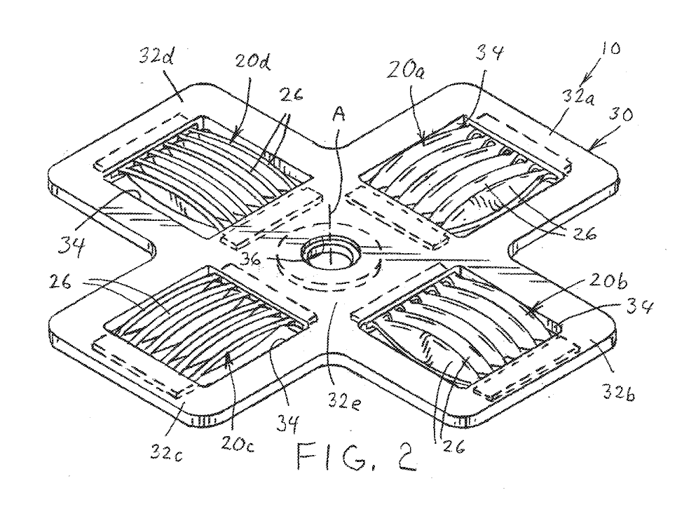

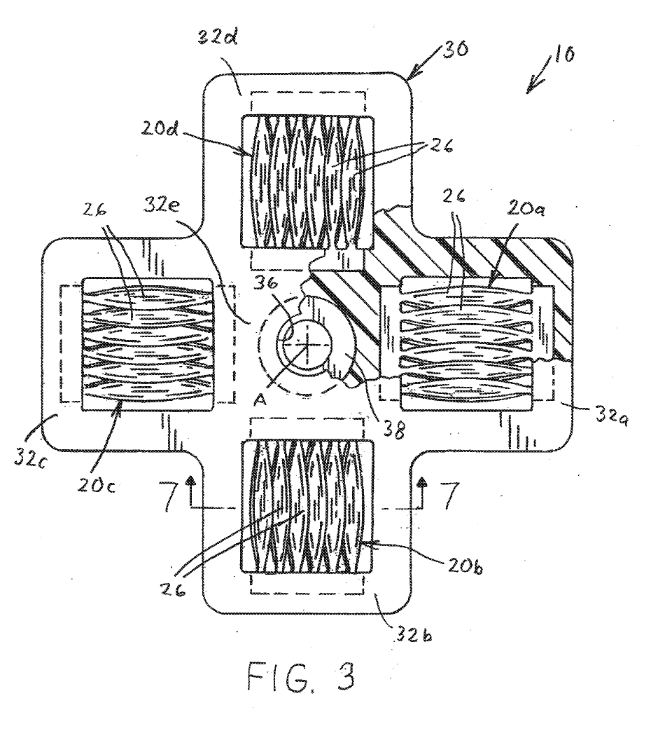

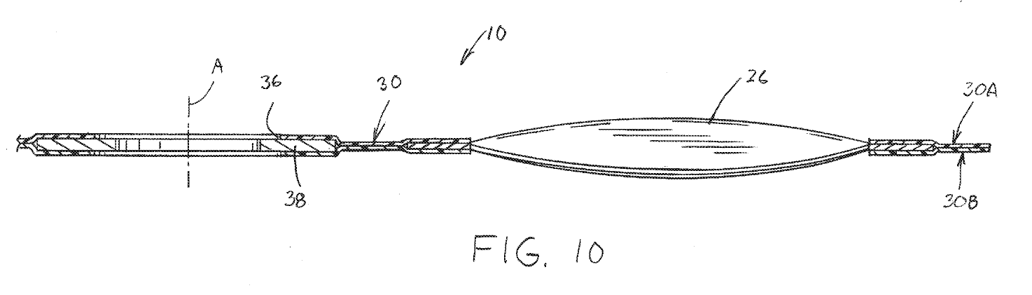

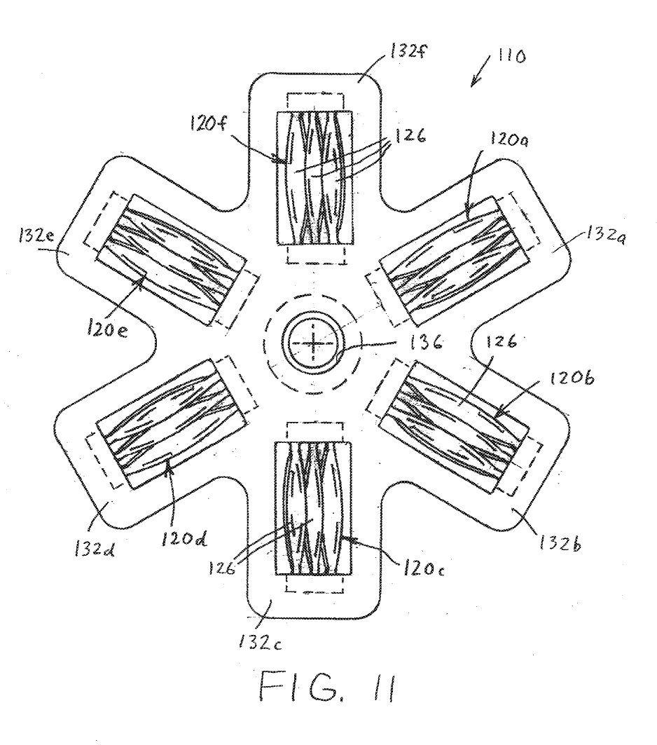

Referring now to the drawings, wherein the showings are for the purpose of illustrating a preferred embodiment of the invention only and not for the purpose of limiting same, FIGS. 1 through 10 illustrate an electrical connector for establishing an electrical connection between two flatly overlapping current conducting elements. The drawings show a connection formed between a pair of generally flat conductors 12, 14, wherein conductor 12 is designated as an “upper conductor” and conductor 14 is designated as a “lower conductor.” In the embodiment shown, the upper and lower conductors 12, 14 are designed to pivot about an axis, designated A in the drawings.

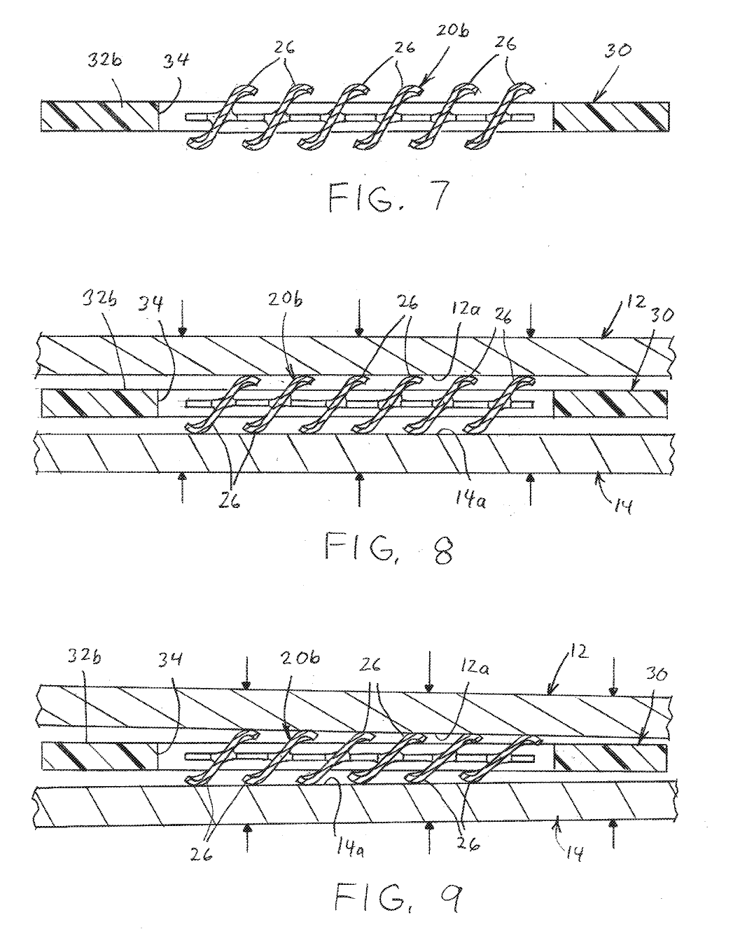

Electrical connector 10 is designed to be disposed between upper and lower conductors 12, 14. Electrical connector 10 is generally comprised of a plurality of spaced apart contact modules designated 20a, 20b, 20c, 20d, embedded within a nonconductive housing or frame 30. Frame or housing 30 is formed of a nonconductive material. Housing 30 has a thickness such that the surface edges of contact modules 20a, 20b, 20c, 20d extend above and below the respective upper and lower surfaces of frame or housing 30, as best seen in FIG. 7. Frame 30 may be injection molded of a polymer material, such as, by way of example and not limitation, PET, PEN or polyamide. According to one embodiment of the invention, frame 30 is formed from an upper layer 30A and lower layer 30B, as illustrated in FIG. 1, of a nonconductive material using an adhesive to bind upper and lower layers 30A, 30B together with the contact module sections 20a, 20b, 20c, 20d, sandwiched therebetween. According to one aspect of the present invention, housing 30 is formed from upper and lower layers 30A, 30B of a film using an adhesive to bond layers 30A, 30B together and to sandwich contact modules 20a, 20b, 20c, 20d therebetween. A metallic or polymer washer 38 may be centrally disposed in inner section 32e.

In the embodiment shown, frame 30 is in the form of a cross having four leg sections 32a, 32b, 32c, 32d that extend outwardly from a generally rectangular inner section 32e. Each leg section 32a, 32b, 32c, 32d includes an opening 34 to receive a contact module 20a, 20b, 20c, 20d. Contact modules 20a, 20b, 20c, 20d are disposed within each of openings 34 of leg sections 32a, 32b, 32c, 32d, as shown in the drawing. A central opening 36 is disposed through inner section 32e. In the embodiment shown, opening 36 extends through the opening in washer 38.

Each contact module 20a, 20b, 20c, 20d is formed from a plurality of louver bands (lamellae) 26 that are used as contact elements. In the embodiment shown, each contact module 20a, 20b, 20c, 20d is comprised of a plurality of louver bands (lamellae) 26 that form a band segment. The dimensions and number of louver bands (lamellae) 26 in each contact module 20a, 20b, 20c, 20d are based upon the desired current carrying capacity for the contact module 20a, 20b, 20c, 20d and the overall current carrying capacity of connector 10. In the embodiment shown, each contact module 20a, 20b, 20c, 20d is formed of six bladed louver bands (lamellae) 26. More specifically, in the embodiment shown, each contact module 20a, 20b, 20c, 20d is formed from a section of LOUVERTAC Strip, Part Number 192002-3 (LAOG), manufactured and sold by the TE Connectivity of 1050 Westlakes Drive, Berwyn, Pa. 19312 UNITED STATES. (See Attachment A.) By way of example and not limitation, louver bands (lamellae) 26 manufactured and sold by Multi-Contact AG can be also used to form contact modules 20a, 20b, 20c, 20d.

Housing 30 has a thickness such that the edges of louver bands (lamellae) 26 extend above and below the top and bottom surfaces of housing 30, as shown in FIG. 7. In accordance with one aspect of the present invention, louver bands (lamellae) 26 are oriented to extend generally parallel to a line extending through axis A. In other words, each of louver band (lamellae) 26 in each contact module 20a, 20b, 20c, 20d extends generally radially outward from axis A.

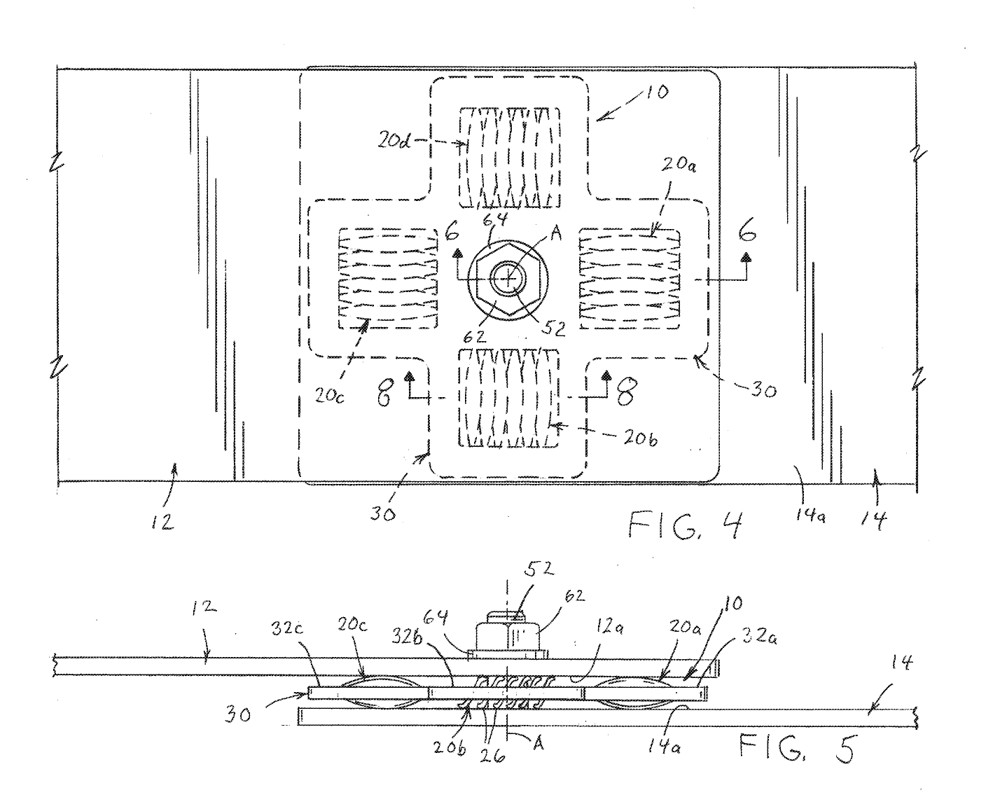

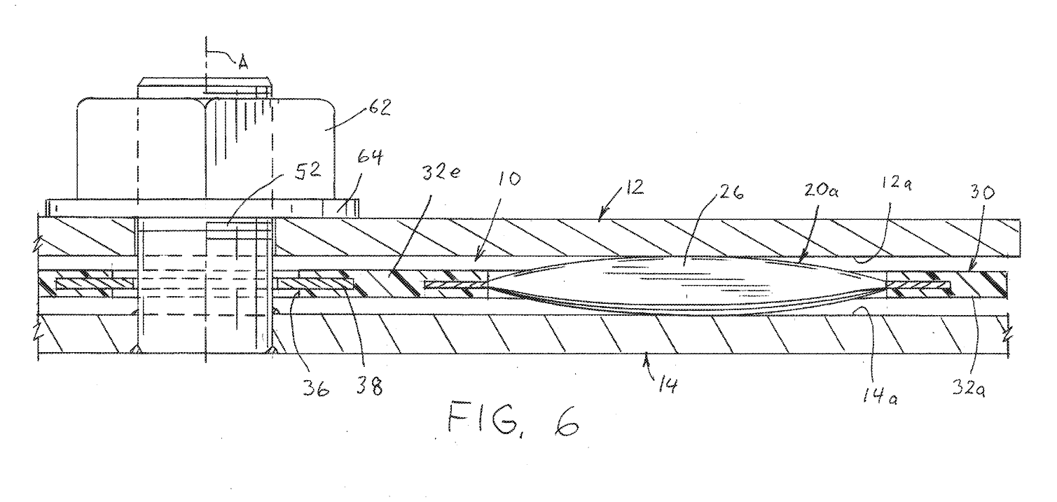

Referring now to FIGS. 4-9, the use and operation of electrical connector 10 shall be described. A threaded rod 52, best seen in FIG. 6, extends from a flat surface of one of the conductors 12, 14. In the embodiment shown, threaded rod 52 extends through lower conductor 14. Threaded rod 52 may be press fit into lower conductor 14 or may be brazed or welded to lower conductor 14, as illustrated in FIG. 6. Threaded rod 52 extends upward from upper surface of the lower conductor 14. An opening through upper conductor 12 is dimensioned to receive rod 52. Electrical connector 10 is disposed on rod 52 and is positioned between upper and lower conductors 12, 14, as best shown in FIG. 6. In this respect, rod 52 extends through opening 36 in central region 32e of housing 30.

A conventional fastener 62 threadingly receives rod 52 to secure upper conductor 12 to lower conductor 14 with electrical connector 10 positioned therebetween. In the embodiment shown, washer 64 is provided. As indicated above, upper and lower conductors 12, 14 are preferably rotatable relative to each other about axis A that extends along the axis of threaded rod 52. As best illustrated in FIGS. 8 and 9, threaded fastener 62 on rod 52 compresses upper conductor 12 towards lower conductor 14, and at the same time, compresses louver bands (lamellae) 26 of contact modules 20a, 20b, 20c, 20d of electrical connector 10 between the opposing surfaces of upper and lower conductors 12, 14, thereby electrically connecting the facing surfaces 12a, 14a of the conductors 12, 14 to each other.

Because housing 30 is formed of an electrically nonconductive material, all current flow is isolated through contact modules 20a, 20b, 20c, 20d, thereby allowing more accurate control of the current carrying ability of connector element 10. Moreover, because contact modules 20a, 20b, 20c, 20d are disposed in leg sections 32a, 32b, 32c, 32d that extend outward from housing 30 and because housing 30 is formed of a flexible material, each leg section 32a, 32b, 32c, 32d can basically flex relative to other leg sections 32a, 32b, 32c, 32d, thereby allowing contact modules 20a, 20b, 20c, 20d within each leg section 32a, 32b, 32c, 32d to maintain good contact between upper and lower conductors 12, 14 in the event of flexing or twisting of the conductors 12, 14.

FIG. 11 illustrates an alternate embodiment of the present invention, wherein six spaced apart contact modules 120a, 120b, 120c, 120d, 120e, 120f are disposed in leg sections 132a, 132b, 132c, 132d, 132e, 132f that extend outwardly from the central region of the housing. As further illustrated therein, the number of louver bands (lamellae) 126 within each contact module 120a, 120b, 120c, 120d, 120e, 120f can be modified to modify the current carrying capacity of each contact module 120a, 120b, 120c, 120d, 120e, 120f.

Electrical connector 10 shown and described above in FIGS. 1-10 disclose a cross-shaped device. FIG. 11 illustrates another embodiment of an electrical connector 110 showing contact modules 120a, 120b, 120c, 120d, 120e, 120f radially disposed about a central axis. As will be appreciated by those skilled in the art, the present invention is not limited to structures, wherein the contact modules 120a, 120b, 120c, 120d, 120e, 120f are disposed about a central axis.

It is contemplated that rectangular strips (not shown) can be arranged to have contact modules spaced apart in a rectangular pattern. These and other configurations find advantageous application according to the present invention. In this respect, the present invention basically comprises a plurality of contact modules spaced apart in a flexible non-conductive frame.

Modifications and alterations of the structures shown in the drawings will become apparent to those skilled in the art after reading the present specification. It is intended that all such modifications and all variations being included in so far as they come within the scope of the patent as claimed or the equivalence thereof.

Having described the invention, the following is claimed:

1. An electrical connector for establishing an electrical connection between two flatly overlapping current conducting elements, said electrical conductor comprised of a plurality of spaced apart contact modules formed of louver sections held within a nonconductive, flexible frame.

2. An electrical connector as claimed in claim 1, wherein the frame is formed of a nonconductive polymer material.

3. An electrical connector as claimed in claim 1, wherein each contact module is disposed within a leg section that extends outwardly from a central region of the frame.

4. An electrical connector as claimed in claim 1, wherein said conducting elements can rotate relative to each other and can flex relative to each other.

5. An electrical connector as claimed in claim 1, wherein individual contact modules are isolated from each other in a nonconductive frame.

6. An electrical connector as claimed in claim 1, wherein each contact module can flex and be oriented in planes different from the other contract modules.

7. An electrical connector as claimed in claim 1, wherein each contact module is disposed within a leg portion that extends outwardly from a central region of the frame and each leg portion is flexible relative to the other leg portion.
